(19) United States
(12) Patent Application Publication
(10) Pub. No.: US 2024/0309273 A1
(43) Pub. Date: Sep. 19, 2024

(54) REDUCED VOLATILE ORGANIC COMPOUND SURFACTANT COMPOSITIONS

(71) Applicant: Dow Global Technologies LLC, Midland, MI (US)

(72) Inventors: Qianyuan Shan, Shanghai (CN); Cheng Shen, Shanghai (CN); Jian Zou, Shanghai (CN); Zhouhua Ji, Shanghai (CN); Shuyu Duan, Shanghai (CN); Hongying Wang, Shanghai (CN)

(21) Appl. No.: 18/576,448

(22) PCT Filed: Oct. 6, 2021
(86) PCT No.: PCT/CN2021/122514

§ 371 Date: Jan. 4, 2024

(51) Int. Cl. C09K 23/42; C09K 15/06; C09K 15/30

(52) U.S. Cl. CPC C09K 23/42; C09K 15/06; C09K 15/30

(57) ABSTRACT

A surfactant composition includes 60 wt % or greater of a surfactant based on a total weight of the surfactant composition. 0.01 wt % to 1 wt % of an antioxidant, and 0.01 wt % to 5 wt % of a hydroxyl amine having structure (I) based on the total weight of the surfactant composition wherein R₁, R₂ and R₃ of Structure (I) are independently selected from the group consisting of H, an alkanolamine, or a hydroxyl alkyl group with linear or branched carbon chain having from 1 to 8 carbons, and R₄ of Structure (I) is selected from the group consisting of an alkanolamine, or a hydroxyl alkyl group with linear or branched carbon chain having from 1 to 8 carbons.

### BACKGROUND

### Field of the Disclosure

The present disclosure is directed to a surfactant composition and more specifically to a surfactant composition that exhibits a reduced concentration of volatile organic compounds.

### INTRODUCTION

Volatile organic compounds (“VOCs”) are compounds having a high vapor pressure. VOCs are introduced into products and compositions in a variety of manners. For example, the manufacturing of a product may leave VOCs in the product that will off gas over time. Additionally or alternatively, VOCs can be produced during storage of a product as a result of oxidation or exposure to elevated thermal conditions. Examples of VOCs include aldehydes, ketones, and various forms of acids. VOCs are typically emitted as gases from the product and may produce offensive odors and cause other issues. In view of these concerns, consumers and manufacturers have a heightened attention to the removal or reduction of VOCs in products.

Attempts have been made at addressing common VOCs. For example, World Intellectual Property Organization Publication 2018148898 (“the '898 publication”) discloses the use of polyurethane foams that exhibit reduced levels of formaldehyde and acetaldehyde emissions. The '898 publication discloses in Tables 1 and 3 the use of approximately 0.1 wt % of an aminoalcohol alone removed 30% of the aldehydes, that use 1.5% of an antioxidant alone resulted in a 53.41% increase of aldehydes present, and the combination of 0.1 wt % of aminoalcohol and 1.5 wt % of antioxidant reached an aldehyde removal rate of 54.38%. The antioxidant used was a blend of hindered phenolic antioxidants and butylated hydroxytoluene. Despite an apparent interactive effect between the aminoalcohol and the hindered phenolic and butylated hydroxytoluene antioxidants, a sizeable quantity of aldehydes and other VOCs remained present in the composition of the '898 publication.

In view of the foregoing, it would be surprising to discover a composition utilizing an amine compound and antioxidant that is able to reduce the total VOC concentration of aldehyde, ketone, ester, alcohol and acids to by 70% or greater.

### SUMMARY OF THE DISCLOSURE

The inventors of the present application have discovered a composition utilizing an amine compound and antioxidant that is able to reduce the total VOC concentration of aldehyde, ketone, ester, alcohol and acids to by 70% or greater. The inventors of the present application have discovered that the incorporation of 0.01 weight percent (“wt %”) to 1 wt % of an antioxidant and 5 wt % or less of a hydroxyl amine having structure (I) into a surfactant composition comprising 60 wt % or greater of a surfactant reduces aldehyde, ketone, ester, alcohol and acid VOCs simultaneously and reduces total VOC content by 70% or greater. Such a result is surprising in that despite the relatively minor amounts of antioxidant and hydroxyl amine, a large impact on total VOCs present in the surfactant composition is achieved. Further surprising is that such a combination works given the uncertainty introduced by using different hydroxyl amines, antioxidants and systems than demonstrated in the prior art. These results are advantageous in that they allow for the production and distribution of surfactant compositions that will not significantly contribute to a downstream product's total VOC content.

The present invention is particularly useful in coating, cleaning, and adhesive applications.

According to a first feature of the present disclosure, a surfactant composition includes 60 wt % or greater of a surfactant based on a total weight of the surfactant composition, 0.01 wt % to 1 wt % of an antioxidant, and 0.01 wt % to 5 wt % of a hydroxyl amine having structure (I) based on the total weight of the surfactant composition wherein R₁. R₂ and R₃ of Structure (I) are independently selected from the group consisting of H, an alkanolamine, or a hydroxyl alkyl group with linear or branched carbon chain having from 1 to 8 carbons, and R₄ of Structure (I) selected from the group consisting of an alkanolamine, or a hydroxyl alkyl group with linear or branched carbon chain having from 1 to 8 carbons.

According to a second feature of the present disclosure, the surfactant is an alkoxylated surfactant.

According to a third feature of the present disclosure, the surfactant is an ethoxylated non-ionic surfactant.

According to a fourth feature of the present disclosure, the surfactant has structure (II) wherein n of structure (II) is 3 to 11.

According to a fifth feature of the present disclosure, n of structure (II) is 7 to 9.

According to a sixth feature of the present disclosure, the surfactant has structure (III) and wherein x of structure (III) is 2 to 8 and y of structure (III) is 3 to 40.

According to a seventh feature of the present disclosure, the surfactant composition comprises 0.01 wt % to 0.1 wt % of the antioxidant based on a total weight of the surfactant composition and 0.01 wt % to 0.1 wt % of hydroxyl amine based on a total weight of the surfactant composition.

According to an eighth feature of the present disclosure, wherein the hydroxyl amine is selected from the group consisting of diethanolamine, aminoethyl ethanolamine, diisopropanolamine or combinations thereof.

According to a ninth feature of the present disclosure, the antioxidant is selected from the group consisting of: hydrazine, phenylhydrazine, semicarbazide, carbohydrazide, DL-α-tocopherol, tetramethyl-4-piperidinol, propyl gallate and combinations thereof.

According to a tenth feature of the present disclosure, the antioxidant is DL-α-tocopherol and the hydroxyl amine is aminoethyl ethanolamine.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); IEC refers to International Electrotechnical Commission; EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise specified.

As used herein, Chemical Abstract Services registration numbers (“CAS #”) refer to the unique numeric identifier as most recently assigned as of the priority date of this document to a chemical compound by the Chemical Abstracts Service.

### Surfactant Compositions

The present disclosure is directed to a surfactant composition. The surfactant composition includes a surfactant, an antioxidant and a hydroxyl amine. As explained in greater detail below, the introduction of the antioxidant and the hydroxyl amine aid in reducing and/or eliminating a variety of VOCs from the surfactant composition such that the surfactant composition does not significantly contribute to the VOC content of downstream applications. The surfactant composition may be utilized in coating, cleaning, and adhesive applications.

### Hydroxyl Amine

The surfactant composition comprises the hydroxyl amine. As used herein, the term “hydroxyl amine” means a chemical compound having anime and hydroxyl groups, functionalities, or moieties. The hydroxyl amine is characterized by Structure (I)

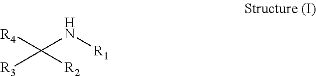

wherein R₁, R₂ and R₃ are independently selected from the group consisting of H, an alkanolamine, or a hydroxyl alkyl group with linear or branched carbon chain having from 1 to 8 carbons, and R₄ selected from the group consisting of an alkanolamine, or a hydroxyl alkyl group with linear or branched carbon chain having from 1 to 8 carbons. The hydroxyl amine may be selected from the group consisting of diethanolamine, tris (hydroxyl-methyl) amino-methane, aminoethyl ethanolamine, diisopropanolamine, 2-amino-1-butanol, 2-amino-2-ethyl-1,3-propanediol, 2-amino-2-methyl-1-propanol, 2-amino-1-methyl-1,3-propanediol, N-methylethanolamine, N-butylethanolamine, monoisopropanolamine, mono-sec-butanolamine, di-sec-butanolamine other hydroxyl amines and combinations thereof.

The surfactant composition may comprise 0.01 wt % to 5 wt % of the hydroxyl amine based on the total weight of the surfactant composition: For example, the surfactant composition may comprise 0.01 wt % or greater, or 0.05 wt % or greater, or 0.10 wt % or greater, or 0.25 wt % or greater, or 0.50 wt % or greater, or 0.75 wt % or greater, or 1.00 wt % or greater, or 1.50 wt % or greater, or 2.00 wt % or greater, or 2.50 wt % or greater, or 3.00 wt % or greater, or 3.50 wt % or greater, or 4.00 wt % or greater, or 4.50 wt % or greater, while at the same time, 5.00 wt % or less, or 4.50 wt % or less, or 4.00 wt % or less, or 3.50 wt % or less, or 3.00 wt % or less, or 2.50 wt % or less, or 2.00 wt % or less, or 1.50 wt % or less, or 1.00 wt % or less, 0.75 wt % or less, or 0.50 wt % or less, or 0.25 wt % or less, or 0.10 wt % or less, or 0.05 wt % or less of the hydroxyl amine based on the total weight of the surfactant composition.

### Surfactant

As stated above, the surfactant composition comprises the surfactant. As used herein, the term “surfactant” means a compound that lowers the interfacial tension between two immiscible phases of dissimilar chemistry. The surfactant may be ionic or non-ionic. The surfactant may be alkoxylated with one or more ethylene oxide (i.e., ethoxylated), propylene oxide (i.e., propoxylated) and/or butylene oxide (i.e., butoxylated) components. The surfactant may have Structure (II)

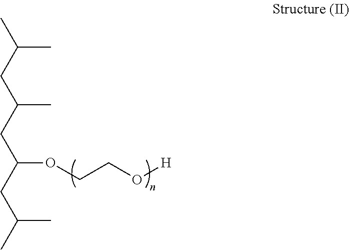

wherein n of structure (II) is 3 or greater, or 4 or greater, or 5 or greater, or 6 or greater, or 7 or greater, or 8 or greater, or 9 or greater, or 10 or greater, while at the same time, 11 or less, or 10 or less, or 9 or less, or 8 or less, or 7 or less, or 6 or less, or 5 or less, or 4 or less. The variable “n” describes the average molar units of oxyethylene in structure (II). As defined herein, the n value is tested and determined by Proton Nuclear Magnetic Resonance Spectroscopy and Carbon-13 Nuclear Magnetic Resonance Spectroscopy. The surfactant may have Structure (III)

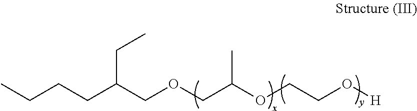

wherein y of structure (III) is 3 or greater, or 4 or greater, or 5 or greater, or 10 or greater, or 15 or greater, or 20 or greater, or 25 or greater, or 30 or greater, or 35 or greater, while at the same time, 40 or less, or 35 or less, or 30 or less, or 25 or less, or 20 or less, or 15 or less, or 10 or less, or 5 or less, or 4 less. X of structure (III) is 2 or greater, or 3 or greater, or 4 or greater, or 5 or greater, or 6 or greater, or 7 or greater, while at the same time, 8 or less, or 7 or less, or 6 or less, or 5 or less, or 4 or less, or 3 or less. The variable “x” describes the average molar units of oxypropylene utilized in structure (III) and the variable “y” describes the average molar units of oxyethylene in structure (III). As defined herein, the x and y values are tested and determined by Proton Nuclear Magnetic Resonance Spectroscopy and Carbon-13 Nuclear Magnetic Resonance Spectroscopy. The surfactant may be a blend of surfactants such as Structure (II), Structure (III) and/or other surfactants.

The surfactant composition comprises 60 wt % or greater of the surfactant based on the total weight of the surfactant composition. For example, the surfactant composition may comprise 60 wt % or greater, or 61 wt % or greater, or 62 wt % or greater, or 63 wt % or greater, or 64 wt % or greater, or 65 wt % or greater, or 66 wt % or greater, or 67 wt % or greater, or 68 wt % or greater, or 69 wt % or greater, or 70 wt % or greater, or 71 wt % or greater, or 72 wt % or greater, or 73 wt % or greater, or 74 wt % or greater, or 75 wt % or greater, or 76 wt % or greater, or 77 wt % or greater, or 78 wt % or greater, or 79 wt % or greater, or 80 wt % or greater, or 81 wt % or greater, or 82 wt % or greater, or 83 wt % or greater, or 84 wt % or greater, or 85 wt % or greater, or 86 wt % or greater, or 87 wt % or greater, or 88 wt % or greater, or 89 wt % or greater, or 90 wt % or greater, or 91 wt % or greater, or 92 wt % or greater, or 93 wt % or greater, or 94 wt % or greater, or 95 wt % or greater, or 96 wt % or greater, or 97 wt % or greater, or 98 wt % or greater, or 99 wt % or greater, while at the same time, 99.98 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less, or 90 wt % or less, or 89 wt % or less, or 88 wt % or less, or 87 wt % or less, or 86 wt % or less, or 85 wt % or less, or 84 wt % or less, or 83 wt % or less, or 82 wt % or less, or 81 wt % or less, or 80 wt % or less, or 79 wt % or less, or 78 wt % or less, or77 wt % or less, or 76 wt % or less, or 75 wt % or less, or 74 wt % or less, or 73 wt % or less, or 72 wt % or less, or 71 wt % or less, or 70 wt % or less, or 69 wt % or less, or 68 wt % or less, or 67 wt % or less, or 66 wt % or less, or 65 wt % or less, or 64 wt % or less, or 63 wt % or less, or 62 wt % or less, or 61 wt % or less based on the total weight of the surfactant composition.

### Antioxidant

The surfactant composition comprises the antioxidant. The antioxidant is selected from the group consisting of hydrazine, phenylhydrazine, semicarbazide, carbohydrazide, DL-α-tocopherol, tetramethyl-4-piperidinol, propyl gallate, other antioxidants and combinations thereof. The surfactant composition comprises 0.01 wt % to 1.00 wt % of the antioxidant. For example, the surfactant composition comprises 0.01 wt % or greater, or 0.05 wt % or greater, or 0.10 wt % or greater, or 0.20 wt % or greater, or 0.30 wt % or greater, or 0.40 wt % or greater, or 0.50 wt % or greater, or 0.60 wt % or greater, or 0.70 wt % or greater, or 0.80 wt % or greater, or 0.90 wt % or greater, while at the same time, 1.00 wt % or less, or 0.90 wt % or less, or 0.80 wt % or less, or 0.70 wt % or less, or 0.60 wt % or less, or 0.50 wt % or less, or 0.40 wt % or less, or 0.30 wt % or less, or 0.20 wt % or less, or 0.10 wt % or less of the antioxidant based on the total weight of the surfactant composition.

### EXAMPLES

### Materials

The following materials were used in the examples.

Surfactant 1 is Structure (III) with an x of 5 and a y of 9 and having a CAS number of 64366-70-7. Surfactant 1 has 99 wt % or greater actives and is available from The Dow Chemical Company, Midland, MI, USA.

Surfactant 2 is Structure (II) with an n of 8 having a CAS number of 60828-78-6, having Surfactant 2 is a 90 wt % actives and 10 wt % aqueous composition and is available from The Dow Chemical Company, Midland, MI, USA.

DEA is diethanolamine having a CAS number of 111-42-2 and is available from The Dow Chemical Company, Midland, MI, USA.

AEEA is aminoethyl ethanolamine having a CAS number of 111-41-1 and is available from available from The Dow Chemical Company, Midland, MI, USA.

DIPA is diisopropanolamine having a CAS number of 110-97-4 and is available from available from The Dow Chemical Company, Midland, MI, USA.

TMP is tetramethyl-4-piperidinol having a CAS number of 2403-88-5 and is available from Shanghai Energy Chemicals Co. Ltd., Shanghai, China.

CBH is a 5 wt % carbohydrazide in water solution. Carbohydrazide has a CAS number of 497-18-7 and is available from Sigma-Aldrich., St. Louis, Missouri.

SVE is synthetic vitamin E, also known as DL-α-tocopherol, having a CAS number of 10191-41-0 and is available from Sigma-Aldrich., St. Louis, Missouri.

### Sample Preparation and Testing

The comparative examples (“CE”) and inventive examples (“IE”) were prepared by first combining the designated constituents in a sample container. The container was then placed on a shaking table for two hours at 300 revolutions per minute. All samples exhibited a homogenous appearance at the end of shaking. The samples were kept at approximately 23° C. for forty eight hours before headspace gas chromatography-mass spectrometry (“HS GC-MS”) analysis was performed on the samples.

An Agilent 7890A Gas chromatograph, Agilent 5975C mass spectrometer and an Agilent 7697A headspace auto sampler were utilized to analyze the examples. The Gas chromatograph column was an SOLGEL-wax column (sn. 1297586B08, p/n 054787) having a 30 m×250 μm×1 μm dimension. The carrier gas used was helium at 1.0 mL/minute constant flow. The gas chromatograph oven program was 50° C., hold 5 minutes, 10° C./minute ramp to 250° C., hold 3 minutes. The Gas chromatograph was set in scan mode with a source temperature of 230° C., a MS Quad temperature of 150° C., and an acquisition scan mode looking for masses from 29 Daltons to 400 Daltons. The headspace oven was heated to 130° C. for 15 minutes. The HS GC-MS was performed on 20 mg to 30 mg of sample that was put into 20 mL headspace vials for analysis. All samples were prepared for duplicate, and the average results are provided. All VOCs were semi-quantified using toluene as equivalent, and their response factor to toluene was regarded as ‘1’. An aliquot of 2.0 μg of toluene was injected into headspace vial, and toluene peak area was used for semi-quantification.

### Results

Table 1 provides composition and performance data for compositions including surfactant 1. The hydroxyl amine (“HA”) and antioxidant (“AO”) are provided along with their respective amounts. The balance of the sample is surfactant 1. Table 2 provides composition and performance data for examples including surfactant 2. The hydroxyl amine and antioxidant are provided along with their respective amounts. The balance of the sample is surfactant 2. For both Table 1 and Table 2, each set of experiments had a control sample (“cont”) to establish baseline VOC concentrations. The removal rate was calculated by subtracting the quotient of an example's total VOC divided by the total VOC of the control from 1 and then multiplying the result by 100. The column “group” indicates which control sample and which examples correspond to one another. The VOC and total VOC values are provided in parts per million.

TABLE 1

| | | | HA | | AO | | | Hexanal, |
|---|---|---|---|---|---|---|---|---|
| Ex | Group | HA | amount (wt %) | AO | Amount (wt %) | 4-heptanone | 3-heptanone | 2-ethyl- |
| Cont | A | | 0 | | | 6.4 | 29.1 | 241.1 |
| CE1 | A | AEEA | 0.02 | | | 0 | 9.8 | 40.8 |
| Cont | B | | | | | 0.5 | 9.1 | 80.3 |
| CE2 | B | DEA | 0.05 | | | 0 | 3.1 | 10.1 |
| Cont | C | | | | | 0.1 | 5.8 | 61.3 |
| CE3 | C | DIPA | 0.05 | | | 0 | 3.4 | 15.8 |
| Cont | D | | | | | 0.4 | 12.7 | 125.1 |
| CE4 | D | | | CBH | 0.01 | 0 | 9.3 | 63.1 |
| Cont | E | | | | | 0 | 6.9 | 64.2 |
| CE5 | E | | | TMP | 0.05 | 0 | 7.3 | 56.6 |
| Cont | F | | | | | 0.8 | 11 | 98.9 |
| CE6 | F | | | SVE | 0.05 | 0 | 4 | 13.1 |
| Cont | G | | | | | 0.4 | 12.7 | 125.1 |
| IE1 | G | AEEA | 0.025 | TMP | 0.025 | 0 | 2.1 | 14.7 |
| IE2 | G | DIPA | 0.025 | TMP | 0.025 | 0 | 2.6 | 23.5 |
| IE3 | G | AEEA | 0.025 | SVE | 0.025 | 0 | 3.2 | 12 |
| IE4 | G | DIPA | 0.025 | SVE | 0.025 | 0 | 3.2 | 16.6 |

| | | | Carbonic acid, | | 1,2- | | |
|---|---|---|---|---|---|---|---|
| | 2- | 1,2- | 2-eethylehexyl | Acetic | ethanediol, | Total | Removal |
| Ex | heptanone | propanediol | Isobutyl ester | acid | diacetate | VOC | rate |
| Cont | 0 | 18.1 | 66.5 | 350.5 | 21.6 | 733.3 | |
| CE1 | 0 | 0.7 | 12.8 | 42.0 | 2.1 | 108.2 | 85.24% |
| Cont | 0 | 4.0 | 19.1 | 79.8 | 4.3 | 197.1 | |
| CE2 | 0 | 0.3 | 4.3 | 10.0 | 0.6 | 28.4 | 85.59% |
| Cont | 0 | 4.4 | 13.3 | 118.8 | 5.5 | 209.2 | |
| CE3 | 0 | 2.1 | 6.5 | 53.7 | 2.7 | 84.2 | 59.75% |
| Cont | 0 | 4.9 | 21.8 | 180.4 | 8.9 | 354.2 | |
| CE4 | 0 | 2.6 | 11.6 | 84.4 | 2.8 | 173.8 | 50.93% |
| Cont | 0 | 3.8 | 15 | 113 | 5.3 | 208.2 | |
| CE5 | 0 | 2.8 | 11.3 | 117.9 | 4.8 | 200.7 | 3.60% |
| Cont | 0 | 6.3 | 24.9 | 103.4 | 6.7 | 252.0 | |
| CE6 | 0 | 0 | 4.2 | 10.2 | 0 | 31.5 | 87.50% |
| Cont | 0 | 4.9 | 21.8 | 180.4 | 8.9 | 354.2 | |
| IE1 | 0 | 0.4 | 5.2 | 45.5 | 1 | 68.9 | 80.55% |
| IE2 | 0 | 1.3 | 5.9 | 52.9 | 2 | 88.2 | 75.10% |
| IE3 | 0 | 0.1 | 4.8 | 41.8 | 0.9 | 62.8 | 82.27% |
| IE4 | 0 | 0.5 | 5.8 | 44.3 | 2.2 | 72.6 | 79.50% |

TABLE 2

| | | | | | | | Methyl | |
|---|---|---|---|---|---|---|---|---|
| | | | HA | | AO | Acetone, | isobutyl | Heptane, |
| Ex | Group | HA | amount (wt %) | AO | Amount (wt %) | butanal | ketone | 2,4-dimethyl- |
| Cont | H | | 0 | | | 8.1 | 17.3 | 12.6 |
| CE7 | H | DEA | 0.05 | | | 5.2 | 6.9 | 7.9 |
| Cont | I | | 0 | | | 19.6 | 18.9 | 16.3 |
| CE8 | I | DIPA | 0.05 | | | 9.5 | 8 | 12.9 |
| Cont | J | | | | | 23.3 | 24.1 | 25.6 |
| CE9 | J | | | TMP | 0.02 | 7.2 | 7.5 | 23.9 |
| Cont | K | | | | | 14.1 | 15.5 | 18.1 |
| CE10 | K | | | TMP | 0.05 | 2.7 | 2.3 | 13.7 |
| Cont | L | | | | | 8.1 | 17.3 | 12.6 |
| CE11 | L | | | SVE | 0.05 | 3.6 | 4.8 | 7.7 |
| Cont | M | | | | | 11.2 | 11.7 | 16.9 |
| CE12 | M | | | CBH | 0.01 | 11.8 | 0.5 | 16.7 |
| Cont | N | | | | | 18.3 | 19.4 | 16.3 |
| IE5 | N | DIPA | 0.025 | SVE | 0.025 | 3.1 | 0.5 | 13.1 |

| | Ethanol, | 2-heptanone, | Hydrocarbon | 4-nonanone, | Acetic | Total | Removal |
|---|---|---|---|---|---|---|---|
| Ex | 2-methoxy- | 4,6-dimethyl- | alcohol | 2,6,8-trimethyl- | acid | VOC | rate |
| Cont | 0 | 0.9 | 12.2 | 246.9 | 29.0 | 327.0 | |
| CE7 | 0 | 0.5 | 6.8 | 107.8 | 17.9 | 153 | 53.21% |
| Cont | 0.5 | 1.9 | 5.1 | 244 | 152.3 | 458.6 | |
| CE8 | 0 | 0 | 0.3 | 87.2 | 106.4 | 224.3 | 51.09% |
| Cont | 3.1 | 1.5 | 32.2 | 270.5 | 225 | 605.3 | |
| CE9 | 0.9 | 0 | 22.2 | 72.1 | 47.3 | 181.1 | 70.08% |
| Cont | 0 | 0 | 5.6 | 179.9 | 157.5 | 390.7 | |
| CE10 | 0 | 0 | 0.3 | 26 | 28.1 | 73.1 | 81.29% |
| Cont | 0 | 0.9 | 12.2 | 246.9 | 29 | 327 | |
| CE11 | 0 | 0.5 | 6 | 93.8 | 10.2 | 126.6 | 61.28% |
| Cont | 0 | 0 | 2.3 | 113.2 | 56.4 | 211.7 | |
| CE12 | 0 | 0 | 0.2 | 27.1 | 3.2 | 59.5 | 71.89% |
| Cont | 0.6 | 1.6 | 5.6 | 237.7 | 156 | 455.50 | |
| IE5 | 0 | 0 | 0.6 | 28.2 | 29.4 | 74.90 | 83.56% |

As can be seen from Tables 1 and 2, CE1 through CE12 result a variety of different VOC removal rates depending on the hydroxyl amine or the antioxidant used. When comparing CE1-CE6 with CE7-CE12, the removal rate appears to have a dependency on the type of surfactant in use. Despite the suggestions by the prior art, the combination of both a hydroxyl amine with an antioxidant in the surfactant composition is surprisingly able to simultaneously reduce aldehyde, ketone, ester, alcohol and acid VOCs and reduces total VOC content by 70% or greater. For example, each of IE1-IE5 are able to reduce the total VOC content in the surfactant composition by 70% or greater. Of particular note, IE5 demonstrates that while DIPA and SVE on their own could not achieve a 70% removal rating (see CE8 and CE11), the combined DIPA and SVE additives can achieve a removal rate of 70% or greater. Additionally some combinations of hydroxyl amine and antioxidant demonstrate synergistic results. For example, DIPA and TMP showed relatively low efficiency of 59.75% (CE3) and 3.60% (CE5) respectively, but the combination of these two additives achieves a removal rate of 75.10% in IE2 which demonstrates a significant synergistic effect.

1. A surfactant composition, comprising:
60 wt % or greater of a surfactant based on a total weight of the surfactant composition;
0.01 wt % to 1 wt % of an antioxidant; and
0.01 wt % to 5 wt % of a hydroxyl amine having structure (I) based on the total weight of the surfactant composition: 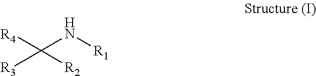
wherein R₁, R₂ and R₃ are independently selected from the group consisting of H, an alkanolamine, or a hydroxyl alkyl group with linear or branched carbon chain having from 1 to 8 carbons, and R₄ selected from the group consisting of an alkanolamine, or a hydroxyl alkyl group with linear or branched carbon chain having from 1 to 8 carbons.

2. The surfactant composition of claim 1, wherein the surfactant is an alkoxylated surfactant.

3. The surfactant composition of claim 2, wherein the surfactant is an ethoxylated non-ionic surfactant.

4. The surfactant composition of claim 3, wherein the surfactant has structure (II) 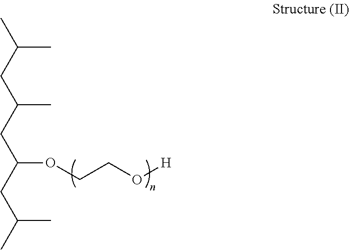
wherein n of structure (II) is 3 to 11.

5. The surfactant composition of claim 4, wherein n of structure (II) is 7 to 9.

6. The surfactant composition of claim 1, wherein the surfactant has structure (III) 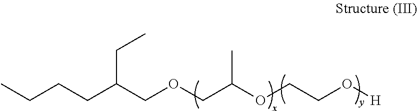
wherein x of structure (III) is 2 to 8 and y of structure (III) is 3 to 40.

7. The surfactant composition of claim 1, wherein the surfactant composition comprises:
0.01 wt % to 0.1 wt % of the antioxidant based on a total weight of the surfactant composition; and
0.01 wt % to 0.1 wt % of hydroxyl amine based on a total weight of the surfactant composition.

8. The surfactant composition of claim 1, wherein the hydroxyl amine is selected from the group consisting of diethanolamine, aminoethyl ethanolamine, diisopropanolamine or combinations thereof.

9. The surfactant composition of claim 1, wherein the antioxidant is selected from the group consisting of: hydrazine, phenylhydrazine, semicarbazide, carbohydrazide, DL-α-tocopherol, tetramethyl-4-piperidinol, propyl gallate and combinations thereof.

10. The surfactant composition of claim 1, wherein the antioxidant is DL-α-tocopherol and the hydroxyl amine is aminoethyl ethanolamine.
